(19) United States
(12) Patent Application Publication
(10) Pub. No.: US 2007/0209720 A1
(43) Pub. Date: Sep. 13, 2007

(54) Washing machine cock

(76) Inventor: Chiu-Lin Chang, Lugang Township (TW)

Correspondence Address: RABIN & BERDO, P.C., Suite 500, 1101 14th Street, N.W., Washington, DC, 20005, US

(21) Appl. No.: 11/368,924

(22) Filed: Mar. 7, 2006

(51) Int. Cl. F16K 3/08

(52) U.S. Cl. 137/625.31

(57) ABSTRACT

A washing machine cock having an indention of limit interface defined by the cock against a handle disposed out of sight when viewed in front, and a precision ceramic valve to replace ball valve of the prior art for improving wear resisting and water sealing up results while maintaining integral and aesthetic appearance of the cock.

### BACKGROUND OF THE INVENTION

(a) Field of the Invention

The present invention is related to washing machine cock, and more particularly to one has a precision ceramic valve to replace the ball vale of the prior art to upgrade wear resisting and water sealing up performances, and a limit interface concealed to maintain integral and aesthetic appearance of the cock.

(b) Description of the Prior Art

Refer to FIGS. 1, 2, and 3 of the accompanying drawings, a washing machine cock of the prior art is essentially comprised of a tee body (10) having its lower end connected to a spindle (11) further connected to water supply pipeline (not illustrated); a sideway water outlet (12) is disposed to the mid section of the body (10) to connect a drain pipeline (not illustrated) for supplying water into a basket of the washing machine; a chamber (13) contained inside the body (10) is provided to accommodate a ball valve (20); the upper portion of the chamber (13) is disposed with a thread (14); a packing nut (15) engages with the thread (14) to limit the assembly between the ball valve (20) and the body (10); the top of a valve stem (21) of the ball valve (20) is connected to a handle (23) with a bolt (22); a semi-circular packing retainer (24) in proper width extends from the lower edge on the front side of the handle (23); the front of the top edge of the body (10) is cut open to define a female indention while the rear edge is reserved to define a male gradation (16); and a limit interface defined by the gradation (16) of the body (10) merely restricts the packing retainer (24) of the handle (23). Accordingly, the ball valve (20) as driven by the handle (23) operates to supply or seal water.

However, the prior art is found with the following flaws:

1. As the switch between water supply and seal is controlled by the ball valve and the water tightness between the ball valve and the body of the cock is poor, washer is needed to secure the expected watertight result. The washer is not made of wear-resisting material and thus is vulnerable to wear out in the process of switch control. Consequently, seepage is introduced.

2. Whereas the water supply and seal control between the handle and the body of the cock is achieved by taking advantage of the packing retainer provided at the front edge of the handle and the gradation on the rear of the body of the cock, a extremely significant gap is created on the other side whether the handle is turned in either way against the body. Though the function of the cock is not affected, the existence of the gap damages the appearance of the cock as a whole.

### SUMMARY OF THE INVENTION

The primary purpose of the present invention is to provide a washing machine cock that allows easier assembly, achieves excellent watertight effects, higher wear-resisting and water sealing performances, more ideal and secured switch control of water supply and seal by using a precision ceramic valve instead of a ball valve found with the prior art.

Another purpose of the present invention is to maintain integral and appearance in visual by providing a gradation to limit the cock in the front so to conceal a gap created in the course of switch control between water supply and seal at where behind the body of the cock.

To achieve the purposes, the present invention is essentially comprised of a body containing a chamber to house a precision ceramic valve; the valve is limited to the top of the body of the cock by means of a packing nut; an indention is disposed on the rear edge of the body of the cock; the indention defines a limit interface on both sides of the gradation in the front of the body of the cock; and a packing retainer is disposed in the rear of the handle locked to the top of a valve stem of the precision ceramic valve. Accordingly, both of the limit interface of the body of the cock and the packing retainer of the handle achieve the purpose of whether the water will be supplied when the handle is turned to drive the precision ceramic valve to supply or seal the water. Whereas the indention of the limit interface defined by the body of the cock is disposed in its rear to conceal the limit construction, integral and aesthetic appearance of the cock is maintained. Furthermore, use of the precision ceramic valve to replace the ball valve of the prior art gives better wear-resisting and sealing up performances thus to significant upgrade the utility value of the present invention.

### BRIEF DESCRIPTION OF THE DRAWINGS

FIG. 1 is an exploded view of the washing machine cock of the prior art.

FIG. 2 is a schematic view of the construction of the prior art.

FIG. 3 is another schematic view showing the construction of the prior art.

FIG. 4 is an exploded view of a preferred embodiment of the present invention.

FIG. 5 is a schematic view showing a precision ceramic valve of the preferred embodiment of the present invention.

FIG. 6 is an exploded view of the precision ceramic valve of the preferred embodiment of the present invention.

FIG. 7 is a schematic view showing a cock of the preferred embodiment of the present invention.

FIG. 8 is a side view showing the cock of the preferred embodiment of the present invention.

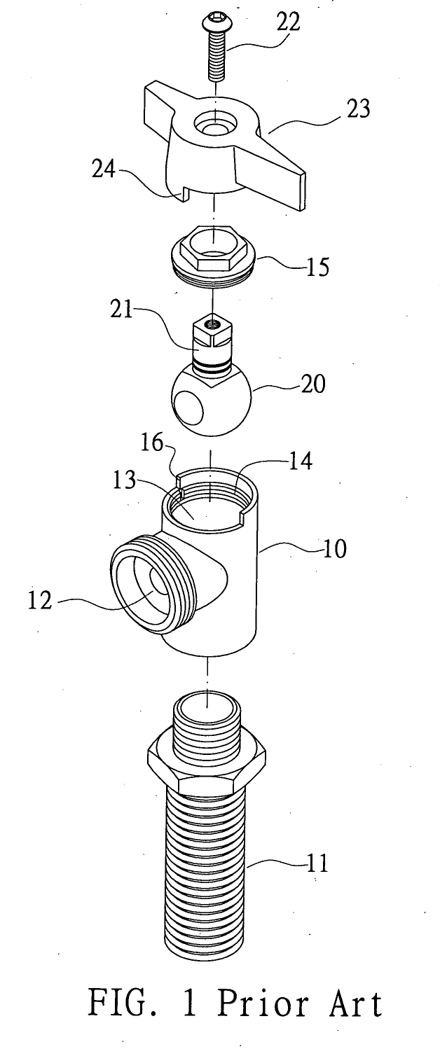

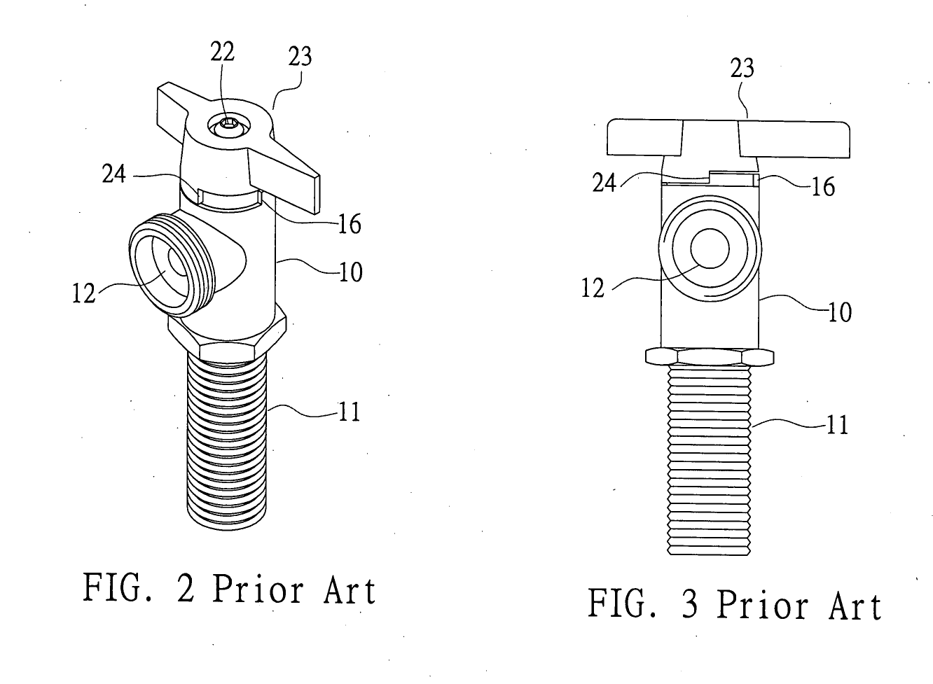

### DETAILED DESCRIPTION OF THE PREFERRED EMBODIMENTS

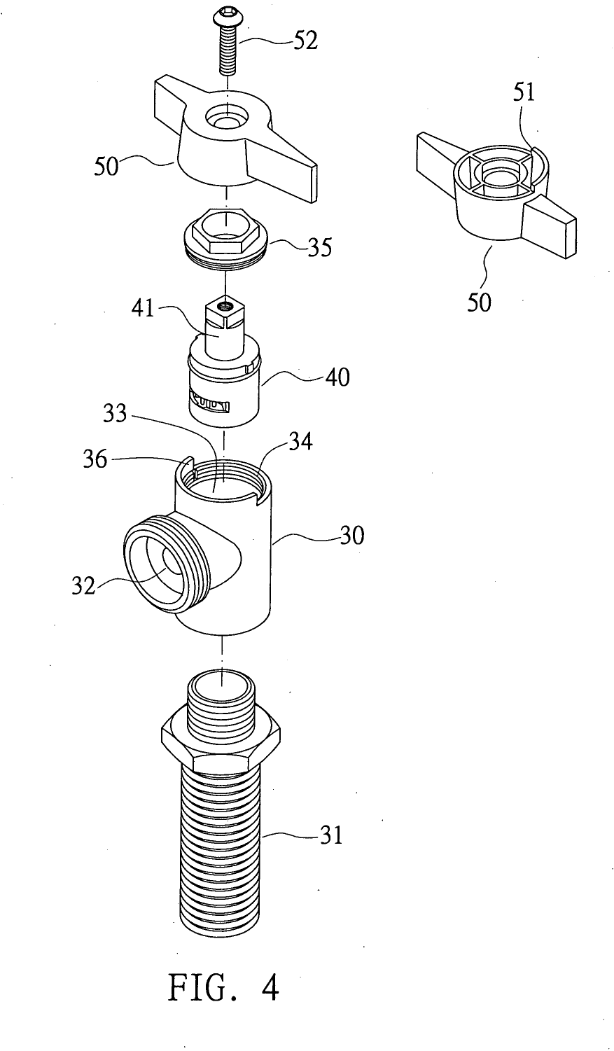

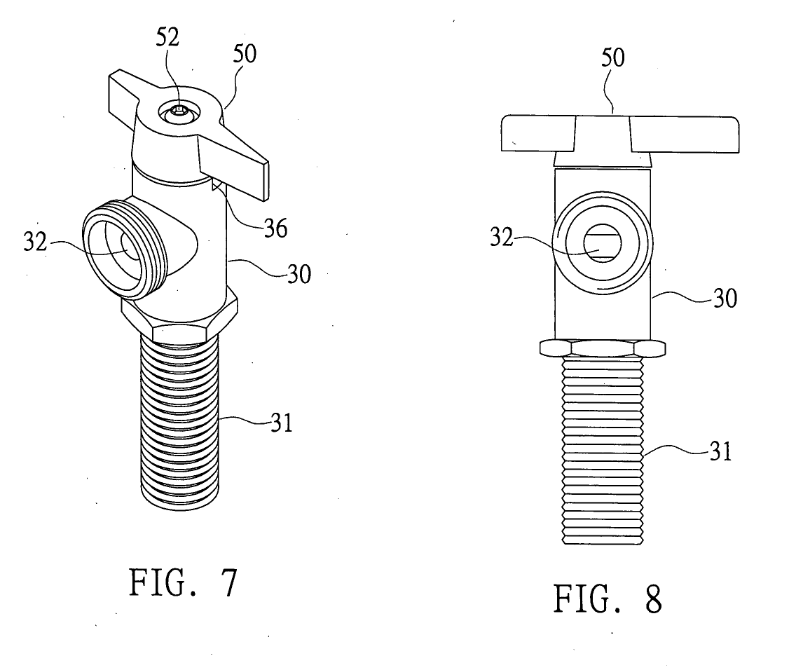

Referring to FIGS. 4 through 8 for a preferred embodiment of the present invention, a washing machine cock is comprised of a Tee shaped body (30) having its lower end connected to a spindle (31) and further to a water supply pipeline (not illustrate). A sideway water outlet (32) connected to a drain pipeline (not illustrated) is disposed to one side of the body (30) to guide the water to flow into a basket of a washing machine. The body (30) contains a chamber (33) to accommodate a precision ceramic valve (40). A thread (34) is disposed on the upper section of the chamber (33) to lock up a packing nut (35) to restrict an assembly of the precision ceramic valve (40) to the body (30). A stem (41) of the precision ceramic valve (40) extends through the packing nut (35) is fastened with a bolt (52) to a handle (50) for manual operation. A semi-circular packing retainer (51) in proper width extends from the lower edge of the handle (50). An indention is cut at the top edge of the body (30) in corresponding to a limit gradation (36) to define a limit interface to limit the packing retainer (51) of the handle (50) for the handle (50) to drive the precision ceramic valve (40) in supplying or sealing the water.

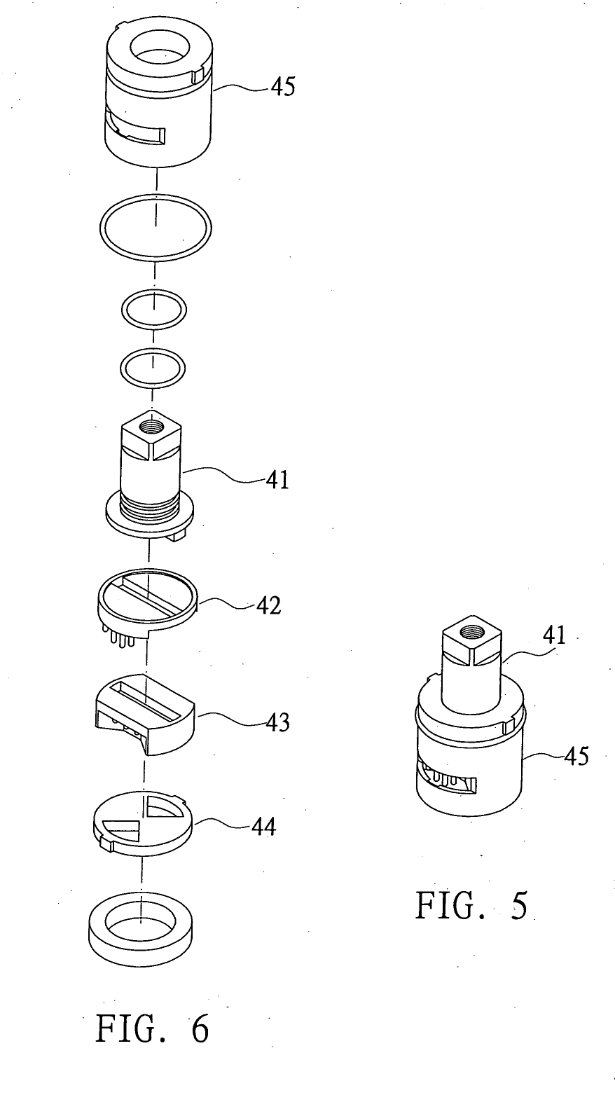

To correct flaws found with the prior art in the use of a ball valve to control switch between water supply and water seal, the precision ceramic valve (40) is used instead of the ball valve. The precision ceramic valve (40), as illustrated in FIG. 5, is essentially comprised of a stem (41), a bifurcate plate (42), a control plate (43), a water inlet plate (44), a casing (45), and multiple washers. Wherein, both of the bifurcate plate (42) and the water control plate (43) are overlapped to each other to be linked to the stem (41). Upon turning the handle (50), the stem (41) of the precision ceramic valve (40) linked to the handle (50) causes both of the bifurcate plate (42) and the water control plate (43) to change their relation with the water inlet plate (44) to determine supplying or sealing up water of the precision ceramic valve (40). Since both of the water control plate (43) and the water inlet plate (44) are made of ceramic material, they provide excellent watertight results. The assembly relation between the precision ceramic valve (40) and the body (30) of the cock is not affected and changed by the operation of water supplying or sealing function. The switch between functions of water supply and seal is achieved by changing the relation between the water control plate (43) and the water inlet plate (44) thus to prevent water leak and wear. The precision ceramic valve by providing better wear resisting and sealing up performances effectively correct the flaws found with the ball valve of the prior art.

To improve the appearance of the washing machine cock, a limit gradation (36) used to limit the handle (50) by the body (30) of the cock is disposed at its front edge and the indention provided at its rear edge. Meanwhile the packing retainer (51) extending from the lower edge of the handle (50) is provided at in the rear of the handle (50). Consequently, without affecting the water supply and seal switch function on the handle by the body (30) of the cock, the indention created in the course of switching between water supply and seal by turning the handle (50) is concealed from the view in facing its user as illustrated in FIG. 8. With the concealed indention, the integral and aesthetic appearance of the cock is maintained.

Use of precision ceramic valve instead of the ball valve and the concealment of the indention of the present invention not only significantly upgrade the wear resisting and water sealing up results but also maintain the integral and aesthetic appearance of the washing machine cock. Therefore, this patent application is filed accordingly.

1. A washing machine cock, comprising:
a precision ceramic valve having
a valve stem,
a bifurcate plate,
a water control plate, the bifurcate plate and the water control plate being connected to an end of the valve stem, so as to rotate therewith,
a water inlet plate that is fixed to prevent rotation when the valve stem, the bifurcate plate and the water control plate are rotated, and
a casing having a smooth, thread-free outer surface, and having a protruding tab, the water inlet plate, the end of the valve stem, the bifurcate plate and the water control plate all being disposed in the casing:
a packing nut:
a handle, a semi-circular packing retainer extending from a lower edge of the handle; and
Tee shaped body, having its lower end connectable to a spindle and further to a water supply pipeline; a sideway water outlet disposed on a front, mid section of the body and being connectable to a water outlet pipeline to guide water into a basket of a washing machine, the body having a chamber to accommodate the valve, the protruding tab of the casing engaging with a corresponding recess in the body to prevent the casing from rotating relative to the body, an upper section of the chamber being threaded to engage with the packing nut to retain the valve in the body, the valve stem of the valve, after passing through the packing nut, being fastened at its top to the handle with a bolt, an indention being cut at a top edge of the body to form a raised limit gradation to define a limit interface for the packing retainer of the handle,
wherein water supply or seal is executed by turning the handle to drive the valve, the function of switching between water supply and seal being achieved by changing a relation between the water control plate and the water inlet plate inside the valve without affecting an assembly relation between the valve and the body cock to prevent members from leaking and wear, thus providing better wear resistance and water sealing up performances.

2. A washing machine cock, comprising:
a valve having a valve stem;
a packing nut;
a handle, a semi-circular packing retainer extending from a lower edge of the handle; and
a Tee shaped body, having a lower end connectable to a spindle and further to a water supply pipeline, a sideway water outlet disposed on a front, mid section of the body and being connectable to a water outlet pipeline to guide water into a basket of a washing machine, the body having a chamber to accommodate the valve, an upper section of the chamber being threaded to engage with the packing nut to retain the valve in the body, the valve stem of the valve, after passing through the packing nut, being fastened at its top to the handle with a bolt, an indention being cut at a top rear edge of the body to form a raised limit gradation to define a limit interface for the packing retainer of the handle, the limit gradation being disposed at the front of the body so that the indention is disposed at a rear of the body and opposite to the sideway water outlet, the packing retainer being disposed at the rear of the body and being received in the indentation, with the indentation and packing retainer being concealed when viewed from the front of the body.
